(19) United States
(12) Patent Application Publication
(10) Pub. No.: US 2007/0062929 A1
(43) Pub. Date: Mar. 22, 2007

(54) Heating unit and the apparatus having the same

(76) Inventors: Akira Mikumo, Itami-shi (JP); Tomoyuki Awazu, Itami-shi (JP); Masuhiro Natsuhara, Itami-shi (JP); Hirohiko Nakata, Itami-shi (JP)

Correspondence Address: MCDERMOTT WILL & EMERY LLP, 600 13TH STREET, N.W., WASHINGTON, DC, 20005-3096, US

(21) Appl. No.: 11/507,655

(22) Filed: Aug. 22, 2006

(30) Foreign Application Priority Data
Aug. 24, 2005 (JP) 2005-242210 (P)

(51) Int. Cl. H05B 3/68

(52) U.S. Cl. 219/444.1; 118/724

(57) ABSTRACT

A heater unit that much improves accuracy in thermal uniformity of an object of heating during cooling, particularly rapid cooling, is provided. The heater unit in accordance with the present invention includes a heater substrate for mounting an object of heating and performing heat treatment thereon, and a cooling module for cooling the heater substrate, and between said heater substrate and the cooling module, an intervening body is arranged. Utilizing deformability of the intervening body, ratio of a non-contact portion can be reduced than when the intervening body is not provided, and temperature uniformity of the heater substrate at the time of cooling can be improved.

This non-provisional application is based on Japanese Patent Application No. 2005-242210 filed with the Japan Patent Office on Aug. 24, 2005, the entire contents of which are hereby incorporated by reference.

### BACKGROUND OF THE INVENTION

1. Field of the Invention

The present invention relates to a heater unit-used for heating a semiconductor substrate or a flat display panel substrate, as well as to a manufacturing/inspecting apparatus mounting the same, and particularly to a heat treatment apparatus used in the process step of photolithography, or a heat treatment apparatus used in the process step of final inspection of a semiconductor substrate.

2. Description of the Background Art

Many apparatuses mounting an object to be heated and performing heat treatment thereon have been developed. Among these, for an application requiring uniform temperature distribution (hereinafter referred to as thermal uniformity) of the object of heating, a heater unit has been known, which is used for heating a semiconductor substrate or a glass substrate, in producing semiconductors and in producing flat display panels. By way of example, it is used for heating and drying liquid resist applied to a substrate in the step of photolithography, or for heating to inspect the substrate at a desired temperature.

In producing semiconductors or producing flat display panels, there is a competition of price reduction through mass-production attained by continuous operation. Therefore, reduction in takt time of a manufacturing/inspecting apparatus has been desired. In order to attain high through put by one apparatus, it is necessary to reduce time necessary for changing heater temperature (heating time, cooling time) inherent to the change in process conditions, let alone the process time of the object of processing while the temperature is kept constant.

In view of the foregoing, the inventors of the present invention have made an invention, in which a cooling module having a desired heat capacity is brought into contact with a heated heater substrate, whereby the temperature of the heater substrate and of an object of heating placed on the heater substrate can be lowered in a short period of time, and as a result, the time necessary for the heat treatment process is reduced (Japanese Patent Laying-Open No. 2004-014655, hereinafter referred to as Patent Document 1).

FIG. 1 is a schematic cross-sectional view showing an example of the heater unit. In the following, the heater unit of Patent Document 1 will be described with reference to FIG. 1. The heater unit in accordance with Patent Document 1 is a heater unit including a heater substrate 2 as a heater portion, a cooling module 3 as a block portion for quickly cooling the heater substrate 2, and a container 8 for shielding, to suppress transfer of heat from the heater to the production apparatus.

Heater substrate 2 is fabricated by arranging a heater body circuit in, for example, a spiral manner on a lower surface of a heater base and by coating the same with an electrically insulating film, to which a power feed line 4 for feeding power to the heater body circuit and a temperature sensor 5 for monitoring the temperature of heater substrate 2 are connected.

Cooling module 3 has a coolant passage formed therein, through which the coolant can be circulated. Cooling module 3 may be driven upward/downward by an elevating mechanism 7 implemented, for example, by an air cylinder, so that it can be brought into contact with/separated from heater substrate 2. In cooling module 3 and container 8, a through hole for inserting a rod 9, power feed line 4 or temperature sensor 5 is provided. Heater substrate 2 and cooling module 8 are contained in container 8, and heater substrate 2 is supported in container 8 by rod 9, and thus, the heater unit is formed.

Next, the process for performing heat treatment on the object of heating using the heater unit will be described. First, the heater body circuit of heater substrate 2, which is at a low temperature state, is electrically conducted, to increase the temperature of heater substrate 2. Thereafter, an object S of heating such as a wafer is mounted on heater substrate 2, so that the object S of heating is heated. After the end of heat treatment for about 60 to about 180 seconds, the object S of heating is taken out from heater substrate 2, and the next object S of heating is mounted on heater substrate 2. After the end of necessary heat treatment, temperature conditions are changed for heat treatment of a different process. When the temperature is to be changed to a higher temperature, the temperature is changed by simply changing the conditions of electric conduction. When the temperature is to be changed to a lower temperature, electric conduction to the heater body circuit is temporarily stopped, cooling module 3 is brought into contact with heater substrate 2 by elevating mechanism 7 so that the heat of heater substrate 2 is taken away by cooling module 3, and thus, the temperature of heater substrate 2 and of the object S of heating is lowered quickly. Here, it is possible to cause a coolant, such as cooling water, to flow through the coolant passage of cooling module 3, and the heat transferred to cooling module 3 is absorbed by the coolant and taken away, so that the heat can effectively be dissipated to the outside of the heater unit. After it is detected by temperature sensor 5 that the temperature has almost reached the set value, electric conduction to the heater body circuit is started again, to maintain the set temperature. In this manner, the change of temperature conditions at the time of cooling is done in a short period of time, and hence, throughput can be improved.

FIGS. 2A and 2B are schematic cross-sectional views of a main portion of a conventional heater unit. FIGS. 2A and 2B show heater substrate 2 and cooling module 3 that can be brought into contact with/separated from heater substrate 2 and, specifically, FIG. 2A shows a state in which cooling module 3 is separated and FIG. 2B shows a state in which cooling module is in contact.

Heater substrate 2 shown in FIGS. 2A and 2B is fabricated by arranging a heater body circuit 21 on a rear surface (hereinafter referred to as a rear surface of the heater substrate) opposite to a surface for mounting an object of heating (hereinafter referred to as a main surface of the heater substrate) of a heater base 22 in, for example, a spiral manner and by providing a coating of an insulating film 23, and what is in direct contact with cooling module 3 when it is brought into contact is the insulating film 23, that is, the insulating film coated on heater body circuit 21.

Insulating film 23 may be formed by applying, for example, a paste-like base material to the entire rear surface of heater substrate 2 by screen-printing, and degreasing and sintering the same. As the material, an insulating material having a thermal expansion curve similar to that of heater substrate 2, such as crystallized glass, glaze glass or a heat-resistant organic matter may be used.

In the conventional heater unit, however, though the main surface of the heater substrate has its surface roughness and flatness refined to mount the object of heating, the surface roughness and flatness of the rear surface of the heater substrate are not made so refined, in order to reduce cost for processing. Here, flatness refers to the shortest distance between two planes, when two planes parallel to each other having the surface of interest positioned therebetween are assumed.

It is sometimes the case that the rear surface of heater base 22 as a base of the rear surface of heater substrate 2 has low flatness. Further, in the conventional example shown in FIGS. 2A and 2B, the pattern of heater body circuit 21 is formed on the rear surface of heater base 22 and, as its thickness varies, the flatness degrades. Further, insulating film 23 is formed on the uneven surface on the pattern of the heater body circuit 21, and its thickness varies as compared with an example in which the film is formed on a flat surface. Further, thickness of the base material paste of insulating film 23 decreases significantly by the degreasing and sintering, and therefore, the paste is applied rather thick by repeating screen-printing a number of times. Such repeated printing is also a factor that causes significant variation in thickness.

Therefore, the flatness of the rear surface of heater substrate 2 has thickness variation of heater body circuit 21 and thickness variation of insulating film 23 added to the original flatness of heater base 22. When heater substrate 2 as such and cooling module 3 are brought into contact with each other, a gap results between the rear surface of heater substrate 2 and cooling module 3, as shown in FIG. 2B. The gap is a factor that hinders heat radiation from heater substrate 2 to cooling module 3, and degrades cooling rate.

Further, unless the state of contact between heater substrate 2 and cooling module 3 is ideally sufficient over the entire contact surface, there arises a problem that temperature uniformity of the heater at the time of cooling is much disturbed, as the portion where the state of contact is perfect is cooled rapidly while the portion of imperfect contact is not easily cooled. The imperfect state of contact is considered to come from the flatness of the contact surfaces of heater substrate 2 and cooling module 3 and local unevenness, protrusions, scratches, fins, burrs, or foreign matters that are generated by machine processing and cannot be avoided in industrial products.

Further, when cooling module 3 that has been sufficiently cooled is operated and brought into contact with heated heater substrate 2 using elevating mechanism 7 as described above, temperature gradient is generated between the contact surface of cooling module 3 and the rear surface of the contact surface immediately after contact, so that thermal expansion of the contact surface becomes much greater than that of the rear surface, promoting deformation similar to bi-metal deformation. Consequently, cooling module 3 itself warps and contact with heater substrate 2 becomes even more unsatisfactory. Further, when mobile cooling module 3 is brought into contact with heated heater substrate 2, it is difficult to realize, in industrial products at low cost, an ideal state of contact in which the surface is fully in ideal contact at one time without any inclined contact, or pressure of contact is uniform over the entire surface.

In producing semiconductors or producing flat display panels, recently, it becomes necessary to realize higher accuracy of fine processing or to realize larger diameter/larger area with high throughput. Therefore, accuracy in thermal uniformity in the process step of heat treatment higher than in the past has been required not only during heating or in maintaining the temperature but also during cooling.

### SUMMARY OF THE INVENTION

The present invention was made in view of the problems described above, and its object is to further improve accuracy of thermal uniformity of the object of heating during cooling, particularly during rapid cooling. By the improvement, particularly in the process of manufacturing a semiconductor device or/and flat display panel, temperature variation in the heater plane can be minimized when temperature conditions are changed to lower temperature side, and when a prescribed temperature has been reached, the heating process can be advanced immediately in accordance with the next conditions.

Another object is to further reduce the time required for changing the temperature during cooling, including stabilization of temperature variation in the plane, and further to improve productivity, performances, production yield and reliability of semiconductor devices and flat display panels manufactured through the process step of heat treatment.

In order to solve the above-described problems, the inventors have found through concentrated study that, by providing a heater substrate for mounting an object of heating and performing heat treatment thereon and a cooling module for cooling the heater substrate, and by arranging an intervening body between said heater substrate and the cooling module, the ratio of non-contact portions can be reduced than when the intervening body is not arranged, because of the deformability of the intervening body. It has been found that, though there are two layers of interfaces formed between the heater substrate and the cooling module, the state of contact can be improved and whereby temperature uniformity of the heater substrate can be improved at the time of cooling.

As said cooling module is made mobile, it follows that the cooling module is at a position away from the heater substrate at the time of normal heating, while at the time of cooling, it is operated to be in contact with the heater substrate with the intervening body interposed, so that the intervening body deforms, and the cooling module can be brought into contact almost with the entire rear surface of the heater substrate. Thus, the temperature uniformity of the heater substrate at the time of cooling can be improved. Further, the function of realizing uniform contact almost over the entire surface is provided, and therefore, it becomes possible to absorb flatness of the contact surfaces of the heater substrate and the cooling module as well as local unevenness, protrusions, scratches, fins, burrs and foreign matters that are caused by machine processing and unavoidable in industrial product, to uniformly transmit heat quantity of the heater substrate to the side of the cooling module at the time of cooling, and to improve temperature uniformity of the heater substrate at the time of cooling.

By setting the thickness of said intervening body to at least 0.3 mm, it becomes possible to absorb the variation in flatness of the heater substrate and the cooling module, the surface state described above and the warp generated when the cooling module is brought into contact, and further, it becomes possible to realize contact with the entire surface, as portions that are locally in firm contact are eliminated. Further, by setting the thickness to at most 3 mm, it is possible to prevent decrease of the cooling rate.

When the intervening body is implemented by foam metal or metal mesh, it becomes possible to absorb the variation in flatness of the heater substrate and the cooling module, the surface state described above and the warp generated when the cooling module is brought into contact, and further, it becomes possible to realize contact with the entire surface, as portions that are locally in firm contact are eliminated.

When the intervening body is implemented by fluoroplastics, polyimide or silicone resin, the effects similar to the above can be attained. When the intervening body is implemented by foam metal containing nickel as a base material, adverse effect to the semiconductor process can be prevented.

Further, when said intervening body is mechanically fixed on the cooling module using a screw, rivet or the like, it becomes possible to prevent degradation of surface contact characteristic caused by separation derived from heat cycles of heating and cooling or concern of outgas, as compared with an example in which it is fixed by using an adhesive component.

Further, by setting flatness of the heater substrate facing the intervening body to at most 300 μm, it becomes possible to maintain surface contact characteristic with the intervening body. Here, “flatness of the heater substrate facing the intervening body” means flatness of the rear surface opposite to the surface for mounting the object of heating, of the heater base forming the heater substrate. By setting flatness of the cooling module facing the intervening body to at most 300 μm, it becomes possible to maintain surface contact characteristic with the intervening body.

Further, when the main component of the heater substrate is at least one selected from the group consisting of aluminum nitride, silicon carbide, aluminum oxide, silicon nitride, copper, aluminum, nickel and silicon, high heating characteristics can be attained and, in addition, rapid heat dissipation from the heater can be attained, realizing sufficient cooling characteristics, as the thermal conductivity is high.

When the main component of said cooling module is at least one selected from the group consisting of copper, aluminum, nickel, magnesium and titanium, rapid heat dissipation to the cooling module through the intervening body becomes possible, realizing sufficient cooling characteristics, as the heat conductivity is high.

Temperature uniformity of the heater at the time of cooling has come to be more important in view of higher throughput, and application to the semiconductor manufacturing/inspecting apparatus or flat panel display manufacturing and inspecting apparatus mounting the heater unit is expected.

According to the present invention, a heater unit that makes more uniform the temperature distribution from the start to the end of cooling can be provided. In the semiconductor manufacturing/inspecting apparatus or the flat display panel manufacturing/inspecting apparatus mounting such a heater unit, temperature distribution of the heater becomes more uniform at the time of cooling than in a conventional apparatus, and therefore, performance and production yield of the semiconductors or flat display panels can be stabilized more easily immediately after the change in temperature condition to the lower temperature side, and reliability can be improved.

Further, according to the present invention, a heater unit in which the time required for cooling is reduced can be provided. In the semiconductor manufacturing/inspecting apparatus or the flat display panel manufacturing/inspecting apparatus mounting such a heater unit, the time required for the process step of heat treatment can be reduced than in the conventional apparatus, and therefore, productivity of the semiconductors and flat display panels can be improved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic cross-sectional view showing an example of a heater unit.

FIGS. 2A and 2B are schematic cross-sectional views of a main portion of a conventional heater unit.

FIGS. 3A and 3B are schematic cross-sectional views of a main portion of the heater unit in accordance with the present invention.

FIG. 4 represents thermal uniformity at the time of cooling of the conventional example.

FIG. 5 represents thermal uniformity at the time of cooling of the present invention.

### DESCRIPTION OF THE PREFERRED EMBODIMENTS

<Heater Unit>

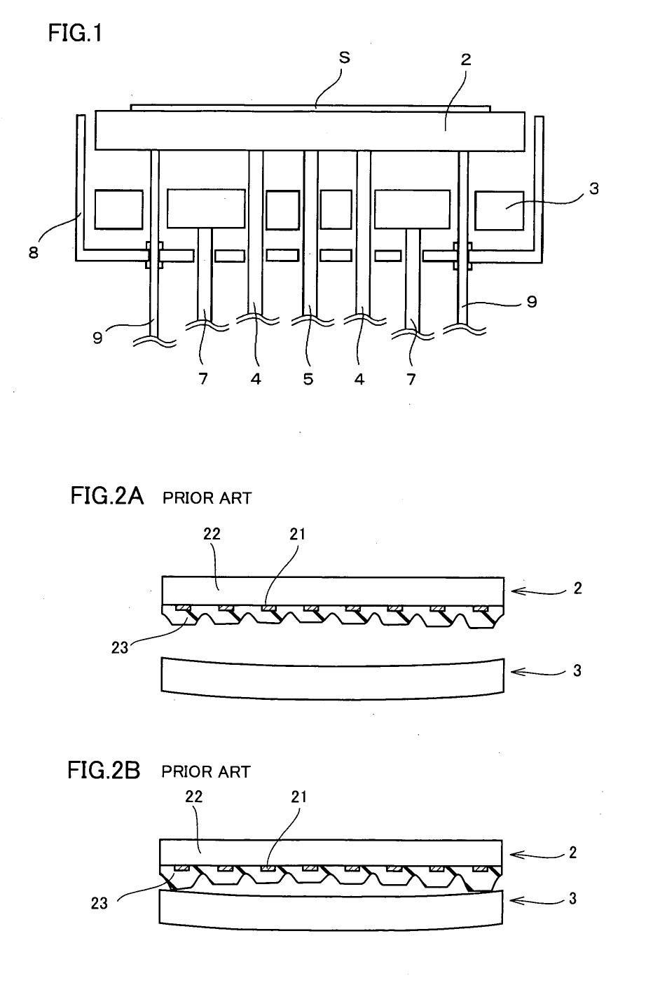

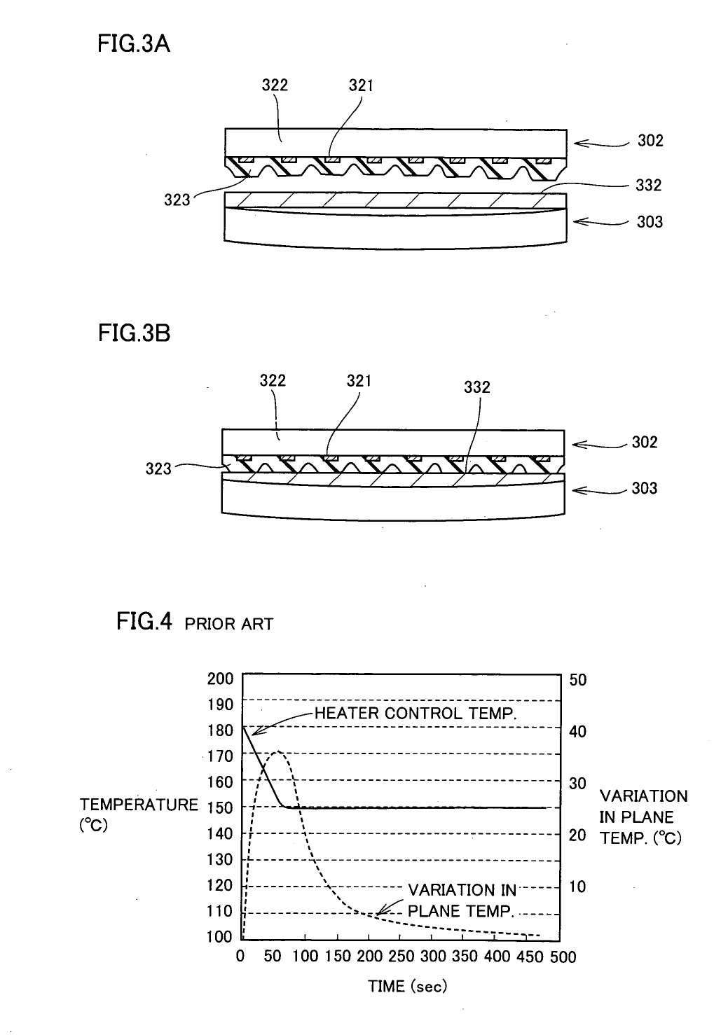

An embodiment of the heater unit in accordance with the present invention will be described with reference to FIGS. 3A and 3B. FIGS. 3A and 3B are schematic cross-sectional views showing a main portion of the heater unit in accordance with the present invention, as an exemplary embodiment of the present invention. Specifically, FIGS. 3A and 3B are schematic cross-sectional views of a heater substrate 302 having a heater body circuit 321 and an insulating film 323 arranged on the rear surface of a heater base 322, and a cooling module 303 that can be brought into contact therewith/separated therefrom, and FIG. 3A shows a state in which cooling module 3 is separated, and FIG. 3B shows a state in which cooling module 3 is in contact. The heater unit of the present invention has, as a whole, the structure shown in FIG. 1.

Heater substrate 302 is fabricated by arranging a heater body circuit 321 in, for example, a spiral manner on a rear surface of a heater base 322 and by coating the same with an electrically insulating film 323, to which power feed line 4 for feeding power to the heater body circuit 321 and temperature sensor 5 for monitoring the heater temperature are connected.

Cooling module 303 has a coolant passage formed therein, through which the coolant can be circulated. Cooling module 303 may be driven upward/downward by an elevating mechanism 7 implemented, for example, by an air cylinder, so that it can be brought into contact with/separated from heater substrate 302. In cooling module 303 (3 in FIG. 1) and container 8, through holes for inserting a rod 9, power feed line 4 or temperature sensor 5 are provided, as shown in FIG. 1.

Here, in the present invention, a relatively soft intervening body 332 is inserted between the rear surface of heater substrate 302 and the contact surface of cooling module 303. This enables more uniform contact when cooling module 303 is brought into contact with heater substrate 302 over the entire surface as shown in FIG. 3B, and variation in the gap distance generated between the two can be reduced. As a result, close contact between the two, including the contact area, can be enhanced, and therefore, the effect of cooling by cooling module 303 can be made uniform over the contact surface, and thermal uniformity of heater substrate 302 in the process of cooling can be improved.

It is preferred that the thickness of said intervening body 332 is 0.3 to 3 mm. The relatively soft material of intervening body 332 is preferably selected from the group consisting of foam metal, metal mesh, fluoroplastics, polyimide and silicone resin. When foam metal is used, nickel cermet, which is a nickel-based foam metal, is preferred. Further, it is preferred that intervening body 332 is mechanically fixed on cooling module 303 using a screw, a rivet or the like. Further, it is preferred that flatness of contacting surfaces of heater substrate 302 and of cooling module 303 is each at most 300 μm. Here, the “contacting surface of heater substrate 302” means the surface of heater substrate 302 that faces the intervening body 332, that is, the rear surface opposite to the surface for mounting the object to be heated of heater base 322 forming the heater substrate 302.

It is preferred that the main component of heater substrate 302 is at least one selected from the group consisting of aluminum nitride, silicon carbide, aluminum oxide, silicon nitride, copper, aluminum, nickel and silicon. Further, if possible, it is preferred that the material of heater base 322 used for heater substrate 302 of the present invention is ceramics. The reason for this is that when metal is used, particles, which should be avoided in the fine processing in device manufacturing, generate and adhere to the wafer. When uniformity in temperature distribution is given priority, aluminum nitride or silicon carbide having high thermal conductivity is preferred as the ceramics. When reliability is given priority, silicon nitride is preferred, as it has high strength and is strong against thermal shock. When cost is of importance, aluminum oxide is preferred.

Further, it is preferred that the main component of cooling module 303 is at least one selected from the group consisting of copper, aluminum, nickel, magnesium and titanium, having good thermal conductivity.

The heater unit in accordance with the present invention is preferably mounted on a semiconductor manufacturing/inspecting apparatus or a flat display panel manufacturing/inspecting apparatus. Then, temperature distribution of the heater becomes more uniform than in the conventional apparatus, and hence, performance, production yield, and reliability of the semiconductors or flat display panels can be improved. Further, the time necessary for the process step of heat treatment can be made shorter than in the conventional apparatus, and productivity of the semiconductors or flat display panels can be improved.

As the material of heater base 322 used for heater substrate 302 of the heater unit in accordance with the present invention, among the ceramics mentioned above, aluminum nitride (AlN) is suitable, considering the balance between performance and cost. A method of manufacturing heater substrate 302 in accordance with the present invention will be described in detail in the following, with reference to an example in which the material of heater base 322 is AlN.

<Method of manufacturing heater substrate>

(1) Fabrication of heater base

First, to aluminum nitride (AIN) raw material powder and sintering agent powder added as needed, a prescribed amount of solvent and binder, and further, a dispersing agent and a deflocculant as needed are added and mixed, whereby raw material slurry is prepared. The raw material powder of AlN having specific surface area of 2.0 to 5.0 m²/g is preferred. When the specific surface area is smaller than 2.0 m²/g, sintering characteristic of AlN degrades. When it exceeds 5.0 m²/g, powder aggregation is too strong, and handling becomes difficult. Further, the amount of oxygen contained in the raw material powder is preferably at most 2 wt%. When the amount of oxygen exceeds 2 wt%, thermal conductivity of the sintered body decreases. The amount of metal impurity other than aluminum contained in the raw material powder is preferably at most 2000 ppm. If the amount of metal impurity exceeds this range, thermal conductivity of the sintered body decreases. Particularly, a IV-group element such as Si and an iron group element such as Fe have high function of decreasing thermal conductivity of the sintered body, and therefore, each content should preferably be at most 500 ppm.

AlN is a sintering-resistant material, and therefore, addition of sintering agent to the AlN raw material powder is preferred. Preferable sintering agent to be added is a rare-earth element compound. The rare-earth element compound reacts on aluminum oxide or aluminum oxynitride at the surface of aluminum nitride powder particle during sintering, and promotes densification of aluminum nitride and removes oxygen as a cause of lower thermal conductivity of the aluminum nitride sintered body. Thus, the thermal conductivity of the resulting aluminum nitride sintered body can be improved.

As the rare-earth element compound, yttrium compound having particularly high function of removing oxygen is preferred. Preferable amount of addition is 0.01 to 5 wt%. When it is smaller than 0.01 wt%, it is difficult to obtain a dense sintered body and thermal conductivity of the sintered body would decrease. When it exceeds 5 wt%, the sintering agent would be present at the grain boundary of aluminum nitride sintered body, and when used in a corrosive atmosphere, the sintering agent existing at the grain boundary would be etched, causing grain separation or particles. More preferably, the amount of addition of the sintering agent is at most 1 wt%. When it is at most 1 wt%, sintering agent would not be present at the triple point of the grain boundary, and hence, corrosion resistance is improved.

As the rare-earth element compound, an oxide, nitride, fluoride or stearate compound of rare earth may be used. Among these, rare-earth oxide is preferred as it is inexpensive and readily available. Further, rare-earth stearate compound has high affinity for organic solvent, and therefore, it is particularly suitable when the aluminum nitride raw material powder and the sintering agent are mixed by using an organic solvent, as it attains good mixing characteristic.

To the aluminum nitride raw material powder and sintering agent powder as described above, a prescribed amount of solvent and a binder are added, and a dispersing agent or a deflocculant as needed is added and mixed, whereby raw material slurry is prepared. The method of mixing may be ball mill mixing or ultra-sonic mixing.

Next, the resulting raw material slurry is molded and sintered, whereby an aluminum nitride sintered body is obtained. Two methods, that is, co-firing and post-metallization are available for this process, and here, an example using the post-metallization will be described.

First, by spray dryer method or the like, the raw material slurry granules are formed. The granules are put in a prescribed mold and by press molding, a molded body is obtained. At this time, pressure for pressing is preferably at least 9.8 MPa. If the pressure is lower than 9.8 MPa, it is difficult to attain sufficient strength of the molded body and the body tends to be damaged during handling.

Though it depends on the binder content or amount of added sintering agent, the density of the molded body should preferably be at least 1.5 g/cm³. When it is smaller than 1.5 g/cm³, distance between grains of the raw material powder becomes relatively large, and therefore progress of sintering becomes difficult. Further, the density of the molded body should preferably be at most 2.5 g/cm³. When it exceeds 2.5 g/cm³, it becomes difficult to sufficiently remove the binder in the molded body in the following step of degreasing. Therefore, it becomes difficult to obtain a dense sintered body such as described above.

Next, said molded body is heated in a non-oxidizing atmosphere, for degreasing. When degreasing is performed in an oxidizing atmosphere such as in the air, the surface of AlN powder is oxidized, and the thermal conductivity of the sintered body decreases. As the non-oxidizing atmosphere gas, nitrogen or argon is preferred. Preferably, the heating temperature for degreasing is at least 500° C. and at most 1000° C. If the temperature is lower than 500° C., the binder cannot be sufficiently removed, and carbon remains excessively in the molded body after degreasing, so that sintering in the subsequent step is hindered. If the temperature exceeds 1000° C., the amount of remaining carbon would be too small, and the function of removing oxygen of an oxide film existing at the surface of AlN powder degrades, so that thermal conductivity of the sintered body decreases.

The amount of carbon left in the molded body after degreasing should preferably be at most 1.0 wt%. If carbon remains by more than 1.0 wt%, sintering is hindered and a dense sintered body cannot be obtained.

Next, the molded body is sintered. Sintering is done in a non-oxidizing atmosphere of nitrogen or argon, at a temperature of 1700 to 2000° C. At this time, dew point of atmosphere gas such as nitrogen used here should preferably be −30° C. or lower. If the atmosphere gas contains more moisture, AlN reacts on the moisture in the atmosphere gas at the time of sintering, forming an oxynitride, and therefore, the thermal conductivity may possibly be decreased. Further, the amount of oxygen in the atmosphere gas is preferably at most 0.001 vol%. If the amount of oxygen is large, the surface of AlN is oxidized, possibly decreasing thermal conductivity.

Further, a suitable jig used at the time of sintering is a boron nitride (BN) molded body. The BN molded body has sufficient thermal resistance at the sintering temperature mentioned above, and its surface has solid lubrication. Therefore, friction between the jig and the molded body can be reduced when the molded body contracts at the time of sintering, and hence, a sintered body with small distortion, that is, small deformation, can be obtained.

The resulting sintered body, that is, the heater base 322 is processed as needed. For the next step of screen-printing a conductive paste, the surface roughness Ra of the sintered body, that is, heater base 322, should preferably be at most 5 μm. When it exceeds 5 μm, defects such as pattern blurring or pinholes tend to occur when the circuit is formed by screen-printing. Surface roughness Ra of at most 1 μm is more suitable. Here, surface roughness Ra represents arithmetic mean roughness, of which detailed definition can be found, for example, in JIS B 0601.

Polishing to attain the surface roughness as such should be performed naturally on both surfaces when both surfaces of the sintered body are subjected to screen-printing. Even when only one surface is subjected to screen-printing, polishing should be performed not only on the surface to be screen-printed but also on the opposite surface. When only the surface to be screen-printed is polished, it follows that the un-polished surface is used for supporting the sintered body at the time of screen-printing. In that case, the un-polished surface may have a projection or foreign matter, which leads to unstable fixing of the sintered body, and the circuit pattern would not be drawn successfully by screen-printing.

At this time, preferably, the parallelism between both processed surfaces should be at most 0.5 mm. When the parallelism exceeds 0.5 mm, thickness of the conductive paste might be varied significantly at the time of screen-printing. Parallelism of at most 0.1 mm is particularly suitable. Further, the flatness of the surface to be screen-printed should preferably be at most 0.5 mm. When the flatness exceeds 0.5 mm, again the thickness of the conductive paste might be varied significantly. Flatness of at most 0.1 mm is particularly suitable. Parallelism and flatness can be measured using a three-dimensional measuring apparatus or the like.

(2) Formation of heater body circuit

On the polished sintered body (heater base 322), a conductive paste is applied by screen-printing, to form an electric circuit, that is, a heater body circuit 321. The conductive paste may be obtained by mixing, with metal powder, a solvent, a binder, and oxide powder, as needed. Considering matching in coefficient of thermal expansion with the ceramics, tungsten, molybdenum or tantalum is preferred as the metal powder. Alternatively, a mixture or an alloy of silver, palladium or platinum may be used.

In order to improve contact strength with AlN, oxide powder may be added. Preferable oxide powder includes an oxide of IIa-group element or IIIa-group element, Al₂O_{3,} or SiO₂. Yttrium oxide is particularly preferred as it has very good wettability to AlN. Preferably, the oxide is added by the amount of 0.1 to 30 wt%. If the amount is smaller than 0.1 wt%, contact strength between the metal layer as the formed electric circuit, that is, heater body circuit 321 and AlN lowers. It the amount exceeds 30 wt%, the metal layer as the electric circuit comes to have high electric resistance.

By sufficiently mixing the powder and adding the binder and solvent, the conductive paste is formed. Using this, the circuit pattern is formed by screen-printing. Preferably, the conductive paste has the thickness of at least 5 μm and at most 100 μm after drying. When the thickness is smaller than 5 μm, electric resistance becomes too high and contact strength lowers. When the thickness exceeds 100 μm, again, contact strength lowers.

Further, preferably, a pattern space of the resistance heater body formed as the heater body circuit 321 should be at least 0.1 mm. If the space is smaller than 0.1 mm, leakage current is generated and it may possibly cause short-circuit, dependent on the applied voltage or temperature, when a current is caused to flow through the resistance heater body. Particularly, when it is used at a temperature of 500° C. or higher, the pattern space should preferably be at least 1 mm, and more preferably at least 3 mm. Not only the resistance heater body pattern but also an RF electrode or an electrode for electrostatic chucking may be formed by screen-printing.

Next, the conductive paste is degreased and fired. Degreasing is performed in a non-oxidizing atmosphere of nitrogen or argon. Preferably, the degreasing temperature is at least 500° C. If it is lower than 500° C., the binder in the conductive paste cannot sufficiently be removed and carbon remains in the metal layer and forms metal carbide at the time of firing. Thus, the metal layer comes to have higher electric resistance.

Firing is preferably performed in a non-oxidizing atmosphere of nitrogen or argon at a temperature of at least 1500° C. If the temperature is lower than 1500° C., grain growth of metal powder in the conductive paste does not proceed, and therefore, electric resistance of the metal layer after firing becomes too high. The firing temperature should not exceed the sintering temperature of ceramics. When the conductive paste is fired at a temperature exceeding the sintering temperature of ceramics, the sintering agent or the like contained in the ceramics starts to evaporate, and grain growth of metal powder in the conductive paste is promoted, so that contact strength between the ceramics and the metal layer would be decreased.

(3) Formation of insulating layer

Next, in order to ensure insulation of the thus formed metal layer, that is, the heater body circuit 321, an insulating film 323 may be formed on the metal layer. The material for insulating film 323 is not specifically limited, provided that the material has low reactivity on the electric circuit and the difference in coefficient of thermal expansion from AlN is at most 5.0×10⁻⁶/K. By way of example, crystallized glass or AlN may be used. By preparing a paste of such a material, performing screen-printing of a prescribed thickness, degreasing as needed and by firing at a prescribed temperature, the insulating film can be formed.

Though not specifically limited, insulating film 323 should preferably has the thickness of at least 5 μm. Film thickness thinner than this is not preferred, as it is difficult to attain the target insulation.

When a metal of high melting point such as W is used as the material of the metal layer, insulating film 323 may be formed by using crystallized glass, glaze glass or organic resin as the material for the insulating film 323, by applying, firing or curing the same. Types of glass that may be used include borosilicate glass, lead oxide, zinc oxide, aluminum oxide and silicon oxide. To the powder of these, organic solvent or binder is added to provide a paste, which is applied by screen-printing. Though the thickness of application is not specifically limited, at least 5 μm is preferred as in the foregoing, because it is difficult to ensure insulation if the thickness is smaller than 5 μm. The firing temperature at this time is not specifically limited. It is noted, however, that firing should preferably be conducted in an inert gas atmosphere of nitrogen or argon, as the metal layer is not oxidation-resistant.

As the conductive paste of (2) above, a mixture or an alloy of silver, palladium or platinum may be used. As regards the mixture or alloy, by adding palladium or platinum to silver, volume resistivity of the conductor increases, and therefore, the amount of addition of palladium or platinum to silver may be adjusted in consideration of the circuit pattern. Such additive has an effect of preventing migration between circuit patterns, and therefore, addition of at least 0.1 parts by weight to 100 parts by weight of silver is preferred.

In order to ensure tight contact with AlN, it is preferred to add metal oxide to such metal powder. By way of example, aluminum oxide, silicon oxide, copper oxide, boron oxide, zinc oxide, lead oxide, rare-earth oxide, oxide of transition metal element, alkaline-earth metal oxide may be added. Here, preferable content of metal oxide is at least 0.1 wt% and at most 50 wt%. The content smaller than 0.1 wt% is not preferable, as tight contact with aluminum nitride would be degraded. The content larger than 50 wt% is not preferable, as sintering of metal component such as silver is hindered.

By mixing the metal powder and the power of metal oxide, and adding an organic solvent or binder, a paste is provided, and by screen-printing in the manner as described above, a circuit may be formed. Here, the thus formed circuit pattern is fired in an inert gas atmosphere of nitrogen or the like, or in the air, at a temperature in the range of 700° C. to 1000° C.

When the conductive paste such as described above is used, in order to ensure insulation between circuits, an insulating film 323 may be formed, by applying and firing or curing crystallized glass, glaze glass or organic resin. Types of glass that may be used include borosilicate glass, lead oxide, zinc oxide, aluminum oxide and silicon oxide. To the powder of these, organic solvent or binder is added to provide a paste, which is applied by screen-printing. Though the thickness of insulating film 323 is not specifically limited, at least 5 μm is preferred as in the foregoing, because it is difficult to ensure insulation if the thickness is smaller than 5 μm. Further, it is preferred that the firing temperature is lower than the temperature at the time of forming the circuit described above. If firing is done at a temperature higher than at the time of firing the circuit, resistance value of the circuit pattern varies significantly, and hence, it is not preferred.

Though not shown in FIGS. 3A and 3B, it is possible to further stack a ceramic sintered body as needed. Stacking using a bonding agent is preferred. As the bonding agent, a paste prepared by adding, to aluminum oxide powder or aluminum nitride powder, an IIa-group element compound or IIIa-group element compound, a binder and a solvent may be used, which paste is applied to the bonding surface through screen-printing or other method. The thickness of the bonding agent to be applied is not specifically limited, though the thickness of at least 5 μm is preferred. When the thickness is smaller than 5 μm, bonding defects such as pinholes or unevenness tend to occur at the bonding layer. At this time, the formed metal layer possibly reacts with the bonding layer, and therefore, it is more preferred that insulating film 323 having aluminum nitride or the like as the main component such as described above is formed on the metal layer.

The ceramic sintered body having the bonding agent applied thereto is subjected to degreasing in a non-oxidizing atmosphere at a temperature of at least 500° C. Thereafter, the ceramic sintered body to be stacked is overlapped, a prescribed load is applied, and heated in a non-oxidizing atmosphere, so that ceramic sintered bodies are joined to each other. The load should preferably be at least 5 kPa. If the load is smaller than 5 kPa, sufficient bonding strength is not attained, or bonding defects mentioned above tend to generate.

The temperature for bonding is not specifically limited, provided that sufficiently close contact can be attained between the ceramic sintered bodies with the bonding layer interposed, and preferable temperature is at least 1500° C. If the temperature is lower than 1 500° C., it is difficult to attain sufficient bonding strength, and bonding defects tend to generate. Preferably, nitrogen or argon is used for the non-oxidizing atmosphere at the time of degreasing and bonding described above.

The ceramic stacked sintered body to be heater substrate 302 can be obtained in the manner described above. As the electric circuit, in place of the conductive paste, a molybdenum line (coil) may be used for a heater circuit, or a molybdenum or tungsten mesh (net-like body) may be used for an electrostatic absorption electrode or RF electrode.

In that case, the molybdenum coil or mesh mentioned above may be embedded in the AlN raw material powder to be subjected to hot pressing for fabrication. The temperature and atmosphere for the hot press may be set in accordance with the sintering temperature and sintering atmosphere of AlN. It is noted, however, that the preferable pressure for hot press is at least 0.98 MPa. If it is lower than 0.98 MPa, a gap might possibly be formed between the molybdenum coil or mesh and AlN, and the performance as a heater substrate would not be attained.

Next, a method of fabricating heater substrate 302 using the co-fire method will be described. First, the raw material slurry described above is formed into a sheet by doctor-blade method. Though there is no specific limitation for sheet formation, preferable thickness of the sheet is at most 3 mm after drying. If the thickness of the sheet exceeds 3 mm, drying shrinkage of the slurry would be too large, and possibility of cracks generated in the sheet becomes higher.

Then, on the sheet as described above, a conductive paste is applied, for example, by screen-printing, whereby a metal layer to be an electric circuit of a prescribed shape is formed. Thus, heater body circuit 321 is formed. As the conductive paste, the one used for the post metallization method may be used. It is noted, however, that in the co-fire method, there is not much influence even when the oxide powder is not added to the conductive paste.

Next, a sheet having the circuit formed thereon and a sheet not having any circuit thereon are stacked. As to the method of stacking, each sheet is set at a prescribed position and overlapped. At this time, a solvent is applied between each of the sheets, as needed. The sheets in the overlapped state are heated as needed. If heating is done, preferable heating temperature is at most 150° C. If the sheets were heated to a higher temperature, the stacked sheets would be deformed significantly. Thereafter, the stacked sheets are pressed to be integrated. The applied pressure is preferably in the range of 1 to 100 MPa. If the pressure is smaller than 1 MPa, the sheets would not be sufficiently integrated and might be separated in the subsequent process steps. If the pressure exceeding 100 MPa is applied, the amount of deformation of the sheet would be too large and not preferable.

Next, the stacked sheet body is subjected to degreasing and sintering in the similar manner as in the post metallization method described above, whereby heater base 322 having heater body circuit 321 formed thereon is obtained. The temperature, amount of carbon and the like for degreasing and sintering are the same as those of the post metallization method. When the conductive paste is printed on the sheet, it is possible to print a heater circuit, an electrostatic absorption electrode and the like on a plurality of sheets respectively, and to stack the sheets, so that a heater substrate having a plurality of electric circuits can be formed in a simple manner. In this manner, the ceramic stacked sintered body to be heater substrate 302 can be obtained.

When the electric circuit such as heater body circuit 321 is formed on an outermost layer of the ceramic stacked body, an insulating layer 323 may be formed on the electric circuit as in the post metallization method described above, in order to protect and ensure insulation of the electric circuit.

The obtained ceramic stacked sintered body is processed as needed. Typically, the body in the sintered state does not satisfy the accuracy required for a semiconductor manufacturing apparatus. As regards the processing accuracy, by way of example, flatness of a surface for mounting an object of heating is preferably at most 0.5 mm, and more preferably at most 0.1 mm. If the flatness exceeds 0.5 mm, a gap is more likely formed between the object of heating and the heater substrate, and the heat of heater substrate would not be uniformly transferred to the object of heating, so that temperature of the object of heating would more likely be uneven.

Further, the surface roughness Ra of the surface for mounting the object of heating is preferably at most 5 μm. If Ra exceeds 5 μm, dropping of AlN grains may possibly increase, because of friction between the heater substrate and the object of heating. The grains dropped would be particles that have adverse influence on processing such as film formation on the object of heating or etching. More suitable surface roughness Ra is at most 1 μm.

In the above-described manner, heater substrate 302 can be obtained. By housing the heater substrate 302 and cooling module 303 in the container, a heater unit that attains stable thermal uniformity can be provided.

### EXAMPLES

### Example 1

As an example in accordance with the present invention, a heater unit having a main portion structured as shown in FIGS. 3A and 3B and has the structure shown in FIG. 1 as a whole was fabricated. As heater base 322, 100 parts by weight of aluminum nitride powder and 0.6 parts by weight of yttrium stearate powder were mixed, 10 parts by weight of polyvinyl butyral as a binder and 5 parts by weight of dibutyl phthalate as a solvent were mixed, and spray-dried to form granules, which were press-molded, degreased in a nitrogen atmosphere at 700° C., sintered in a nitrogen atmosphere at 1850° C., and thus, an aluminum nitride sintered body was fabricated. The aluminum nitride powder used had average grain diameter of 0.6 μm and specific surface area of 3.4 m²/g. The aluminum nitride sintered body was processed to have the diameter of 330 mm and the thickness of 12 mm.

Using 100 parts by weight of W powder having average grain diameter of 2.0 μm, 1 part by weight of Y₂O₃, 5 parts by weight of ethyl cellulose as a binder and butyl carbitol as a solvent, W paste was prepared. For mixing, a pot mill and a three-roll mill were used. Using the W paste, the heater body circuit pattern was formed by screen-printing on said processed aluminum nitride sintered body. Thereafter, it was degreased in a nitrogen atmosphere at 900° C., and sintered in a nitrogen atmosphere at 1800° C., whereby heater body circuit 321 having the thickness of 20 μm was formed. Here, flatness of the sintering jig was strictly managed to maintain flatness of heater substrate 302, so that flatness of the rear surface of heater substrate, that is, the rear surface opposite to the surface for mounting the object of heating of heater base 322 forming heater substrate 302 attained 200 μm.

On the surface having heater circuit 321 formed thereon, ZnO—B₂O₃—Al₂O₃ based glass paste was applied and fired in a nitrogen atmosphere at 700° C., whereby insulating film 323 having the thickness of 80 μm was formed. Further, at the power feed portion, a tungsten terminal was attached by screw fixing, and a nickel electrode was screw-fixed on the tungsten terminal, and thus, heater substrate 302 (2 in FIG. 1) was completed. Further, in heater substrate 302 (2 in FIG. 1), temperature sensor 5 such as shown in FIG. 1 for monitoring temperature was embedded, and power feed line 4 was connected to heater body circuit 321, to enable power conduction.

As cooling module 303 (3 in FIG. 1), an aluminum alloy plate having the diameter of 330 mm and the thickness of 10 mm was prepared. Cooling module 303 was fabricated by machine processing, such that flatness of the surface to be in contact with heater substrate 302 attains 200 μm. Further, in these plates, a flow passage allowing passage of cooling water was formed by bending work of a phosphor deoxidized copper pipe having a diameter of 6 mm and an inner diameter of 4 mm. Further, at opposite ends of the flow passage, an inlet and an outlet for supplying/discharging the cooling water were formed. Further, as shown in FIG. 1, through holes were formed for inserting power feed line 4, temperature sensor 5 and rod 9 for supporting heater substrate 302 (2 in FIG. 1). These plates were fixed by screw-fixing, and cooling module 303 having a flow passage therein was completed. Cooling module 303 (3 in FIG. 1) is adapted to be movable upward/downward by elevating mechanism 7 formed of an air cylinder or the like shown in FIG. 1, and it can be brought into contact/separated from heater substrate 302 (2 in FIG. 1).

Referring to FIG. 1, container 8 is formed of stainless steel, of which sidewall had inner height of 30 mm, inner diameter of 333 mm and thickness of 1.5 mm, and of which bottom had the thickness of 3 mm and openings for power feed line 4, temperature sensor 5 and for fastening rod 9 that supports heater substrate 2 (302 in FIGS. 3A and 3B) with respect to container 8.

In the manner as described above, heater substrate 2 (302 in FIGS. 3A and 3B), cooling module 3 (303 in FIGS. 3A and 3B) and container 8 were assembled using rod 9, elevating mechanism 7 and the like, and the heater unit such as shown in FIG. 1 was completed.

It is noted that heater units were fabricated with intervening body of the types shown in Table 1 attached respectively on the contact surface of cooling module 303. As for the object of heating, a known wafer thermometer having 17 platinum resistance thermometer sensors embedded therein was used to monitor temperature distribution of the object of heating. Though it is not the case that a wafer is kept in the heater unit during cooling in the actual process, in order to measure the degree of thermal uniformity of heater substrate 302 at the time of cooling, the wafer thermometer was kept in the unit at the time of cooling, and variation of plane temperature (difference between the highest temperature and lowest temperature of the 17-point resistance thermometer sensors) was measured.

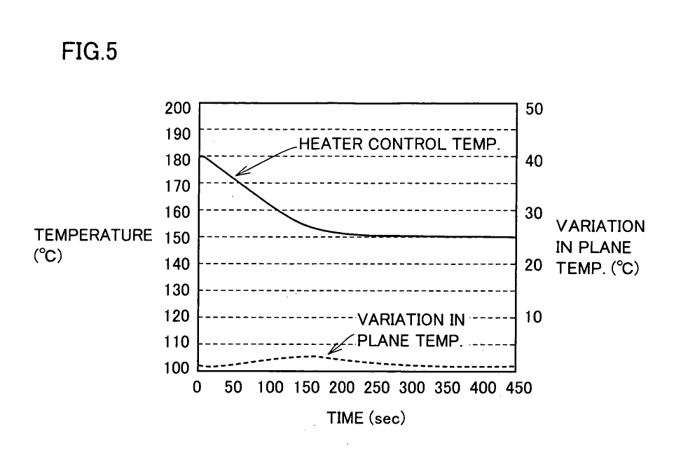

Heater body circuit 321 of heater substrate 302 was electrically conducted to increase the temperature to 180° C., wafer thermometer was inserted and kept for 10 minutes, thereafter electric conduction is stopped, cooling module 303 having water circulated therethrough as the coolant was brought into contact with heater substrate 302 with intervening bodies 332 shown in Table 1 interposed, to cool heater substrate 302 to 150° C., and thereafter, heater body circuit 321 was electrically conducted to maintain the temperature at 150° C. Thermal uniformity (variation in plane temperature) of the wafer thermometer after 60 seconds and 300 seconds from the start of cooling, and the time required until the temperature of the resistance thermometer used for heater control attained to 150° C. after the start of cooling were measured. The results are shown in Table 1 and FIGS. 4 and 5. As described above, flatness of the rear surface of heater substrate and flatness of the surface (contact surface) of cooling module were 200 μm.

TABLE 1

| | | | | Thermal | Cooling from 180° C.→150° C. | | | |
|---|---|---|---|---|---|---|---|---|
| | | | Thickness | conductivity | Thermal uniformity | Thermal uniformity | Required | |
| | | | of | of material | 60 sec. | 300 sec. | cooling | |
| | | | intervening body | (reference) | after cooling | after cooling | time | |
| | Type of intervening body | | (mm) | (W/m · k) | (° C.) | (° C.) | (sec) | Determination |
| Target | — | — | — | — | ≦10° C. | <1.5° C. | ≦200 sec. | Determined |
| | | | | | | | | based on |
| | | | | | | | | references |
| | | | | | | | | on the left |
| Comparative | None | | | | 35 | 2.7 | 50 | B |
| example | | | | | | | | |
| Examples | Metal plate | SUS plate | 0.5 | 17 | 1.1 | 1.7 | 460 | B |
| | | Al(A5052) | 0.5 | 138 | 14.0 | 5.8 | 100 | B |
| | Ceramic | Alumina plate | 1.0 | 20 | Damaged | | | B |
| | plate | AlN plate | 1.0 | 170 | 22.2 | 4.8 | 65 | B |
| | Foam metal | Ni cermet | 0.2 | 90 | 18 | 1.7 | 70 | B |
| | body | | 0.3 | 90 | 9.2 | 1.3 | 85 | A |
| | | | 0.5 | 90 | 6.5 | 1.3 | 100 | A |
| | | | 1.0 | 90 | 1.6 | 1.0 | 158 | A |
| | | | 1.5 | 90 | 2.1 | 1.2 | 175 | A |
| | | | 3.0 | 90 | 2.5 | 1.3 | 190 | A |
| | | | 5.0 | 90 | 2.8 | 1.3 | 300 | B |
| | Metal mesh | Brass mesh | 0.6 | 106 | 1.9 | 1.5 | 170 | A |
| | | | 1.0 | 106 | 2.3 | 1.8 | 200 | A |
| | organic | Fluoroplastic | 0.05 | 0.25 | 24.4 | 1.0 | 55 | B |
| | based sheet | sheet | 1.0 | 0.25 | 2.4 | 1.0 | 100 | A |
| | | Silicone resin | 0.5 | 0.5 | 3.1 | 1.0 | 110 | A |
| | | sheet | | | | | | |
| | | Polyimide | 0.05 | 0.17 | 28.2 | 1.2 | 55 | B |
| | | film | 0.5 | 0.17 | 2.3 | 1.3 | 125 | A |

When intervening body 332 was not provided, the thermal uniformity range of the wafer thermometer attained to 35° C. after 60 seconds, as shown in FIG. 4, and when, by way of example, Ni cermet having the thickness of 1 mm was inserted as intervening body 332, temperature variation of the wafer plane could significantly be reduced to 1.6° C., as shown in FIG. 5. Thermal uniformity range after 300 seconds was 2.7° C. when intervening body 332 was not provided, while it was 10° C. when Ni cermet of 1 mm was provided, and thus, it can be understood that provision of the intervening body is extremely effective. The time necessary for cooling to 150° C. was 50 seconds when intervening body 332 was not provided, while it was 158 seconds when Ni cermet of 1 mm was provided, and provision of the intervening body 332 resulted in longer time. That the control temperature attained to a prescribed temperature does not mean that the conditions for putting in the next wafer are satisfied, as long as there remains variation in plane temperature such as shown in FIG. 4, as in the case where intervening body 332 was not provided. In contrast, when Ni cermet of 1 mm was provided, variation of the plane was very small as shown in FIG. 5, and therefore, though it took 158 seconds for cooling, the in-plane range attained 1.5° C. or lower after 300 seconds from the start of cooling, and conditions for putting in the next wafer were satisfied.

As described above, requirements necessary at the time of changing temperature conditions for cooling were determined to be [1] in-plane variation 60 seconds after the start of cooling ≦10° C., [2] in-plane variation 300 seconds after the start of cooling ≦1.5° C., and [3] time necessary for cooling from 180° C. →150° C. ≦200 seconds, and thermal uniformity characteristics at the time of cooling of various examples were studied, varying conditions of the intervening bodies.

Using Ni cermet with its thickness condition varied, the thermal uniformity characteristics at the time of cooling were studied. As a result, it was found that with the thickness being 0.3 to 3 mm, good thermal uniformity characteristics at the time of cooling could be attained while cooling rate ≦200 sec. was maintained. The results indicated that when the thickness of intervening body 332 was too thin, thermal uniformity range immediately after the start of cooling was unsatisfactory, and when it was too thick, cooling time became too long.

Further, metal mesh and organic-based sheet (fluoroplastic sheet, silicone sheet, polyimide film) that can withstand relatively high temperature also served as the intervening body, and thermal uniformity characteristic could be attained at the time of cooling. When a metal plate or a ceramic plate was used as intervening body 332, tight contact between the contact surfaces could not be improved, and as a result, thermal uniformity characteristic at the time of cooling was not improved, and when an SUS plate was used, the material has low thermal conductivity and, as a result, the time necessary for cooling was very long. When an alumina plate was used, there was a thermal shock at the time of contact with heater substrate 302, causing damage. In “Determination” of Table 1 and Table 2 below, A represents satisfactory characteristics as regards the references [1] to [3], and B represents unsatisfactory characteristics as regards the references [1] to [3].

### Example 2

Heater units similar to those of Example 1 were fabricated. Here, Ni cermet was used, and flatness of heater substrate 302 and flatness of cooling module 303 were varied as shown in Table 2, and variation in thermal uniformity at the time of cooling was measured. It was confirmed that desired thermal uniformity could be attained when flatness of both contacting surfaces was at most 300 μm.

TABLE 2

| | | | | | Cooling from 180° C.→150° C. | | | |
|---|---|---|---|---|---|---|---|---|
| | | | | | Thermal uniformity | Thermal uniformity | | |
| | | | Flatness of | Flatness of | 60 sec. | 300 sec. | Required | |
| | Type of intervening | | heater substrate | cooling module | after cooling | after cooling | cooling time | |
| | body | | (μm) | (μm) | (° C.) | (° C.) | (sec) | Determination |
| Target | — | — | — | — | ≦10° C. | <1.5° C. | ≦200 sec. | Determination |
| | | | | | | | | based on |
| | | | | | | | | references on |
| | | | | | | | | the left |
| Comparative | None | | | | 35 | 2.7 | 50 | B |
| example | | | | | | | | |
| Examples | Foam | Ni cermet | 50 | 200 | 1.2 | 0.8 | 95 | A |
| | metal body | 1.0 mm | 100 | 200 | 1.2 | 0.8 | 100 | A |
| | | | 150 | 200 | 1.5 | 1.0 | 108 | A |
| | | | 200 | 200 | 1.6 | 1.0 | 158 | A |
| | | | 300 | 200 | 5.8 | 1.4 | 180 | A |
| | | | 400 | 200 | 15.2 | 2.8 | 320 | B |
| | | | 200 | 50 | 1.1 | 0.7 | 101 | A |
| | | | 200 | 100 | 1.2 | 0.8 | 106 | A |
| | | | 200 | 150 | 1.6 | 1.0 | 111 | A |
| | | | 200 | 300 | 7.0 | 1.7 | 169 | A |
| | | | 200 | 400 | 15.5 | 3.0 | 340 | B |
| | | | 400 | 400 | 22.2 | 4.8 | 450 | B |

By mounting the heater unit having high accuracy in thermal uniformity in accordance with the present invention including the examples above on a manufacturing apparatus or an inspecting apparatus, the process step of uniform heat treatment exceeding the conventional limit in a shorter takt time becomes possible, and therefore, further improvement in performance, production yield and productivity of semiconductor devices or flat display panels can be realized.

According to the present invention, a heater unit that can make more uniform the temperature distribution from the start to the end of cooling can be provided. In the semiconductor manufacturing/inspecting apparatus or in a flat display panel manufacturing/inspecting apparatus having such a heater unit mounted thereon, temperature distribution of the heater at the time of cooling becomes more uniform than in a conventional apparatus, and therefore, performance and production yield of the semiconductors and flat display panels can be stabilized easily immediately after the change of temperature conditions to the lower temperature side, and hence, reliability can be improved.

Further, according to the present invention, a heater unit in which the time necessary for cooling is reduced, can be provided. In the semiconductor manufacturing/inspecting apparatus or in a flat display panel manufacturing/inspecting apparatus having such a heater unit mounted thereon, the time necessary for the step of heat treatment can be made shorter than in a conventional apparatus, and therefore, productivity of semiconductors and flat display panels can be improved.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A heater unit, including a heater substrate for mounting an object of heating and performing heat treatment, and a cooling module for cooling the heater substrate, comprising an intervening body arranged between said heater substrate and the cooling module.

2. The heater unit according to claim 1, wherein said cooling module is movable, so that it can be brought into contact with and separated from said heater substrate.

3. The heater unit according to claim 1, wherein thickness of said intervening body is at least 0.3 mm and at most 3 mm.

4. The heater unit according to claim 1, wherein said intervening body is foam metal or metal mesh.

5. The heater unit according to claim 1, wherein said intervening body is any of fluoroplastics, polyimide and silicone resin.

6. The heater unit according to claim 4, wherein said intervening body is nickel-based foam metal.

7. The heater unit according to claim 1, wherein said intervening body is fixed on said cooling module.

8. The heater unit according to claim 1, wherein flatness of said heater substrate facing said intervening body is at most 300μm.

9. The heater unit according to claim 1 wherein flatness of said cooling module facing said intervening body is at most 300μm.

10. The heater unit according to claim 1, wherein main component of said heater substrate is at least one selected from the group consisting of aluminum nitride, silicon carbide, aluminum oxide, silicon nitride, copper, aluminum, nickel and silicon.

11. The heater unit according to claim 1, wherein main component of said cooling module is at least one selected from the group consisting of copper, aluminum, nickel, magnesium and titanium.

12. A semiconductor manufacturing/inspecting apparatus comprising the heater unit according to claim 1.

13. A flat display panel manufacturing apparatus comprising the heater unit according to claim 1.
